(19) United States
(12) Patent Application Publication
(10) Pub. No.: US 2009/0016753 A1
(43) Pub. Date: Jan. 15, 2009

(54) IMAGE FORMING APPARATUS AND CONTROL METHOD THEREFOR

(75) Inventor: Nobuhiko Zaima, Abiko-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/169,381

(22) Filed: Jul. 8, 2008

(30) Foreign Application Priority Data
Jul. 10, 2007 (JP) 2007-180972
Jul. 4, 2008 (JP) 2008-175618

(51) Int. Cl. G03G 15/043

(52) U.S. Cl. 399/51

(57) ABSTRACT

An image forming apparatus which improves the degree of freedom for changing the shape, diameter, light intensity distribution of the section of a laser beam. Emission of the plurality of lasers provided in a light source unit is separately controlled based on image data of one pixel. The laser lights emitted from the plurality of lasers are focused and a laser beam is formed. Exposure scanning of a photosensitive body is performed by the laser beam. A light emission pattern of the plurality of lasers is changed according to image data of each pixel.

### BACKGROUND OF THE INVENTION

1. Field of the Invention

The present invention relates to an image forming apparatus and a control method therefor, and more particularly, to an image forming apparatus using an exposure technique for performing image formation by exposure scanning of a photosensitive body by a laser beam and a control method therefor.

2. Description of the Related Art

Image forming apparatuses using an electrophotographic process are conventionally known. In this type of image forming apparatus, generally, exposure scanning of a photosensitive body is performed by a laser beam which is emission-controlled based on image data to form an electrostatic latent image on a surface of the photosensitive body. In this case, a semiconductor laser, a He—Ne laser or the like are generally used as a laser source. The sectional shape (spot shape) of a laser beam emitted from the laser source onto the photosensitive body is circular or elliptical. The light intensity distribution of the beam section assumes a Gaussian distribution shaped like a mountain peaking the center thereof (a single traverse mode).

Accordingly, the electrostatic latent image formed on the surface of the photosensitive body also assumes a Gaussian distribution shaped like a mountain. As a result, a toner image obtained on the photosensitive body by developing the electrostatic latent image by a toner also has a mountain shape by rising high in the center with a large amount of toner deposited thereon. When a transfer paper having stiffness is used, the toner image on the photosensitive body and facing the transfer paper is crushed by a transfer roller, but eventually, a transferred image in which the toner rises in the center is obtained on the transfer paper. On the other hand, in order to ensure a necessary dot diameter and line width, it is necessary to increase the amount of toner deposited on the photosensitive body and the transfer paper since the electrostatic latent image assumes a Gaussian distribution shaped like a mountain. Thus, the toner image having a mountain shape is sometimes formed of a larger amount of toner than a maximum amount of toner by which a predetermined dot diameter and line width can be ensured, which leads to image collapse of an output image on a paper.

Moreover, the toner is scattered by pressurization at the time of transferring and fixing the toner image on the photosensitive body to a recording paper to cause a decrease in image quality. The toner image having a mountain shape also causes such problems that the toner is not uniformly melted to lower the fixability, an electrostatic offset occurs on a fixing roller, or the like. In order to address the problems, a technique described in Japanese Laid-Open Patent Publication (Kokai) No. 8-276619 has been conventionally proposed.

Also, an optimum spot diameter of a laser beam is known to be different depending on an image to be formed such as a binary image, a multi-gradation image or the like. In order to address the problem, a technique described in Japanese Laid-Open Patent Publication (Kokai) No. 8-164634 has been conventionally proposed.

Furthermore, when the spot diameter of a laser beam is reduced in size for obtaining higher resolution, higher definition can be achieved in an image of highlight to halftone. In a region having a high density, however, since the spot size is small, a gap between the laser beams is generated even if light radiation is applied to an entire surface. Thus, a sufficient gradation cannot be obtained. In order to address the problem, a technique described in Japanese Laid-Open Patent Publication (Kokai) No. 2003-285466 has been conventionally proposed.

A higher image quality can be obtained to some extent by the image forming apparatuses according to the conventionally proposed techniques described above. However, as the image quality of digital cameras becomes increasingly high, the image forming apparatuses such as printers are also needed to have a further higher image quality these days. Therefore, it is desirable to more freely control the shape, diameter, light intensity distribution or the like of the section of a laser beam in exposure control of the image forming apparatuses.

### SUMMARY OF THE INVENTION

The present invention is made under such circumstances, and provides an image forming apparatus which improves the degree of freedom for changing the shape, diameter, light intensity distribution of the section of a laser beam and a control method thereof.

In a first aspect of the present invention, there is provided with an image forming apparatus for exposing a photosensitive body by laser lights which are emission-controlled based on image data and forming an image, comprising a light source unit having a plurality of lasers, a control unit adapted to separately control emission of the plurality of lasers based on image data of one pixel, a beam forming unit adapted to focus the laser lights emitted from the plurality of lasers by the emission control of the control unit and form a laser beam, and a scanning unit adapted to perform exposure scanning of the photosensitive body by the laser beam from the beam forming unit, wherein the control unit changes a light emission pattern of the plurality of lasers according to image data of each pixel.

With the arrangement of the present invention, the degree of freedom for changing the shape, diameter, light intensity distribution of the section of a laser beam can be improved, and a higher image quality can be thereby obtained.

In a second aspect of the present invention, there is provided a method for controlling an image forming apparatus for exposing a photosensitive body by laser lights which are emission-controlled based on image data and forming an image, comprising a light emission controlling step of separately controlling emission of a plurality of lasers provided in a light source unit based on image data of one pixel, a beam forming step of focusing the laser lights emitted from the plurality of lasers and forming a laser beam, and a scanning step of performing exposure scanning of the photosensitive body by the laser beam, wherein the light emission controlling step comprises changing a light emission pattern of the plurality of lasers according to image data of each pixel.

Further features of the present invention will become apparent from the following description of exemplary embodiments with reference to the attached drawings.

### BRIEF DESCRIPTION OF THE DRAWINGS

FIG. 1 is a view showing the schematic configuration of an exposure scanning unit of an image forming apparatus according to an embodiment of the present invention.

FIG. 2 is a schematic block diagram of the image forming apparatus having an exposure scanning unit, and mainly showing devices related to an electrophotographic process arranged around a photosensitive drum.

FIG. 3 is a view showing the arrangement relationship of light sources on a surface-emitting laser of FIG. 1.

FIG. 4 is a view showing the relationship between the surface-emitting laser and a collimator lens of FIG. 1.

FIG. 5 is a view showing relations of attribute data (color, character, graphic) of an image, densities, and gradations of respective light sources with light emission patterns.

FIG. 6 is a view used for explaining a dither matrix in the case of representing halftone according to an attribute of image data.

FIGS. 7A and 7B are conceptual views used for explaining pixel data related to a character portion, FIG. 7A showing an electric potential distribution of an electrostatic latent image, and FIG. 7B showing the height of a toner on a recording paper.

FIG. 8 is a conceptual view showing an electric potential distribution of an electrostatic latent image of pixel data related to a graphic image portion.

### DETAILED DESCRIPTION OF THE PREFERRED EMBODIMENTS

The present invention will now be described in detail with reference to the drawings showing preferred embodiments thereof.

It should be noted that the relative arrangement of the components, the numerical expressions and numerical values set forth in these embodiments do not limit the scope of the present invention unless it is specifically stated otherwise.

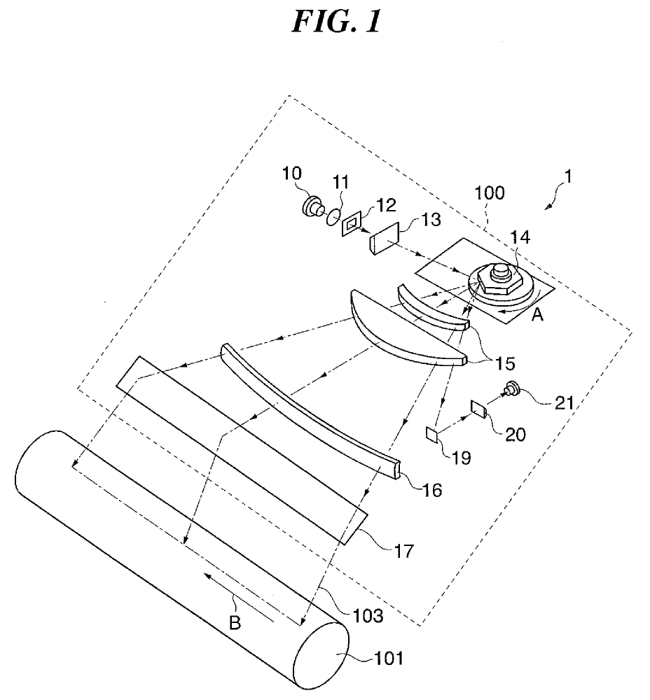

FIG. 1 is a view showing the schematic configuration of an exposure scanning unit of an image forming apparatus according to the embodiment of the present invention.

In FIG. 1, an image forming apparatus 1 according to the present embodiment comprises an exposure scanning unit 100 and a photosensitive drum 101. In the exposure scanning unit 100, a surface-emitting laser (VCSEL: vertical-cavity surface-emitting laser) 10 as a multibeam laser source, a collimator lens 11, an aperture (optical diaphragm) 12, a cylindrical lens 13, a polygon mirror 14, an fθ lens group 15, an optical face tangle error correcting lens 16, and a mirror 17 are schematically arranged in sequence so as to perform scanning on the photosensitive drum 101. Also, the exposure scanning unit 100 comprises a synchronizing mirror 19, a synchronizing cylindrical lens 20, and an optical detector (BD sensor) 21.

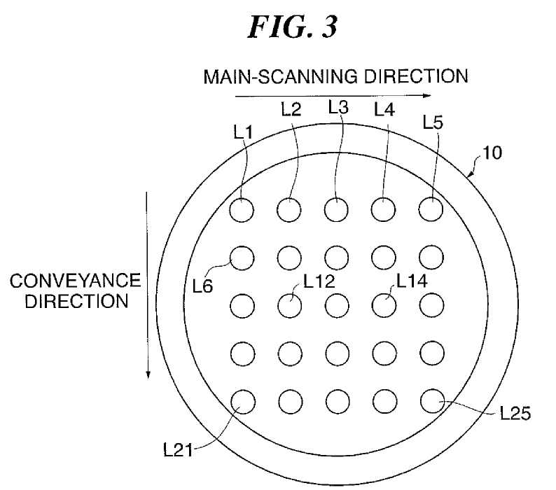

The surface-emitting laser 10 has a plurality of laser sources (L1 to L25) which are arranged in two-dimension as described below in FIG. 3. The plurality of laser sources are separately emission-controlled based on image data. The collimator lens 11 (beam shaping unit) causes a plurality of laser lights (laser beams) emitted from the surface-emitting laser 10 to be one bundled parallel laser beam (light flux). The aperture 12 adjusts the sectional shape (spot shape and spot diameter) of the laser beam from the collimator lens 11.

The cylindrical lens 13 deflects the laser beam only in a sub-scanning direction in consideration of the width (corresponding to the thickness) of the polygon mirror 14 in the sub-scanning direction. The polygon mirror 14 is rotated at a constant velocity (constant angular velocity) in the direction of an arrow A in FIG. 1 by a drive motor (not shown). The fθ lens group 15 corrects distortion so as to ensure temporal linearity of scanning on the photosensitive drum 101. The optical face tangle error correcting lens 16 corrects optical face tangle errors of the polygon mirror 14. The mirror 17 is a reflecting mirror.

Next, a description will be made following an optical path. The laser beams emitted from the surface-emitting laser 10 are converted to the substantially parallel lights by the collimator lens 11, the aperture 12, and the cylindrical lens 13. After that, the laser beam enters the polygon mirror 14 with a predetermined beam diameter. The polygon mirror 14 is being rotated at a constant angular velocity in the rotation direction indicated by the arrow A in the drawing. Along with the rotation of the polygon mirror 14, the incident laser beam is converted to a deflected beam which continuously changes its angle and is reflected. The deflected beam is focused by the fθ lens group 15. At the same time, the fθ lens group 15 performs distortion correction on the laser beam so as to ensure temporal linearity of scanning on the photosensitive drum 101. The laser beam in which the optical face tangle errors of the polygon mirror 14 are corrected by the optical face tangle error correcting lens 16 is reflected by the mirror 17 and is coupled and scanned on the photosensitive drum 101 at a constant velocity in the direction of an arrow B.

Also, the laser beam passing through the fθ lens group 15 from the polygon mirror 14 is reflected by the synchronizing mirror 19, is caused to pass through the synchronizing cylindrical lens 20 and is received by the optical detector 21.

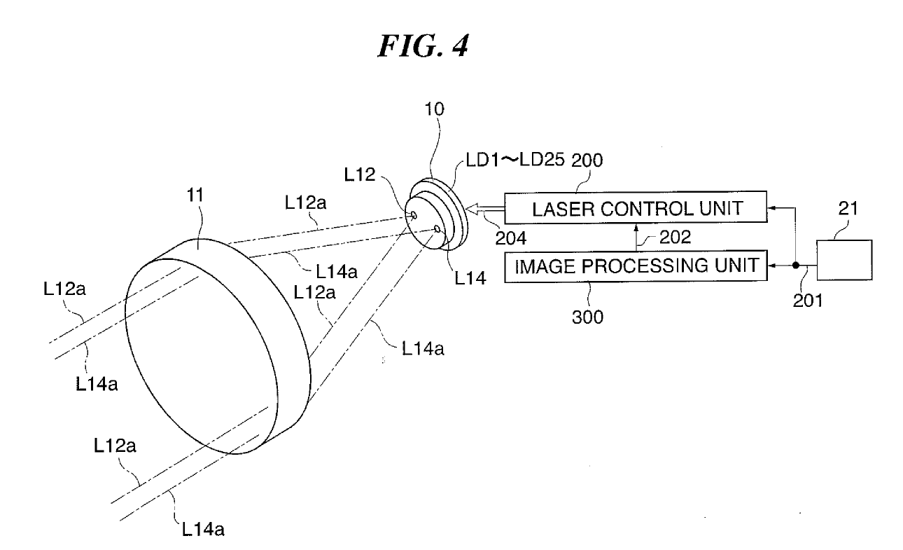

The optical detector 21 generates a horizontal synchronizing signal (BD signal) 201 (FIG. 4) which is a write reference in a main-scanning direction that is the longitudinal direction (axis direction) of the photosensitive drum 101 at the timing when the laser beam enters the optical detector 21. The horizontal synchronizing signal 201 is used as a signal for synchronizing the rotation of the polygon mirror 14 and writing of image data onto the photosensitive drum 101. An image signal 202 is output from an image processing unit 300 (FIG. 4) to a laser control unit 200 (FIG. 4) on the basis of the horizontal synchronizing signal 201.

The laser control unit 200 further controls a current value and a driving time of a driving (light emitting) signal 204 (FIG. 4) for the surface-emitting laser 10 based on the image signal 202 input from the image processing unit 300 in an image section in which a latent image is formed on the photosensitive drum 101. As described above, the laser beams emitted from the surface-emitting laser 10 are converted to the substantially parallel light by the collimator lens 11, the aperture (optical diaphragm) 12, and the cylindrical lens 13, and then, the laser beam enters the polygon mirror 14 with a predetermined beam diameter.

Also, a PDIO (not shown) is arranged as a light receiving element in a peripheral end region of the optical diaphragm 12. A detection signal of the PDIO is used for light emission amount control of the surface-emitting laser 10, namely, auto power control (APC) for determining the current value of the driving (light emitting) signal 204.

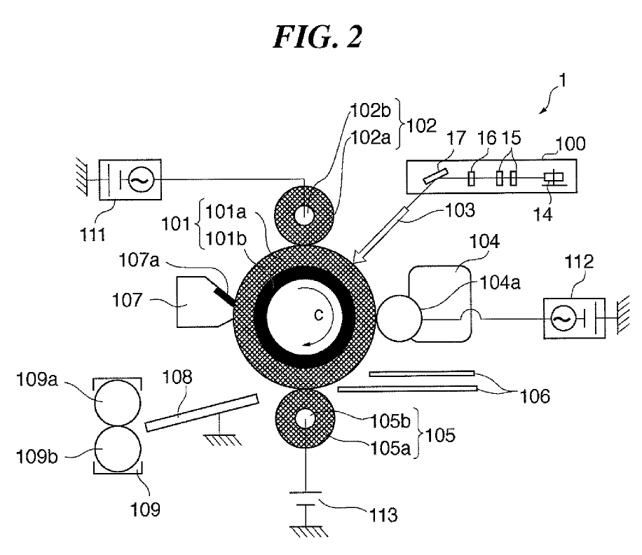

FIG. 2 is a schematic block diagram of the image forming apparatus 1 having the exposure scanning unit 100, and mainly showing devices related to an electrophotographic process arranged around the photosensitive drum 101.

In FIG. 2, the image forming apparatus 1 comprises the exposure scanning unit 100, the photosensitive drum 101, a charging roller 102, a developing device 104, transfer guides 106, a transfer roller 105, a cleaner 107, a conveyance guide 108, and a fixer 109. Also, the image forming apparatus 1 comprises a bias source 111, a developing bias source 112 and a bias source 113, used as power sources.

As shown in FIG. 2, the photosensitive drum 101 configures such that a photosensitive body layer 101a is laminated on a metallic conductive base material 101b having a cylindrical shape. The charging roller 102, the developing device 104, the transfer guides 106, the transfer roller 105, and the cleaner 107 are arranged around the photosensitive drum 101 in the rotation direction indicated by an arrow C.

The charging roller 102 has a core metal 102b and an elastic layer 102a as a surface layer thereof. The charging roller 102 is arranged to uniformly charge the photosensitive drum 101 by a voltage applied to the core metal 102b by the bias source 111. For example, the bias source 111 applies a direct-current bias voltage (DC=−800 V) and an alternating-current bias voltage (AC) to the core metal 102b of the charging roller 102. The charging roller 102 thereby uniformly charges a surface of the photosensitive drum 101 with about −800 V (dark potential: Vd) when contacting the photosensitive drum 101 via the elastic layer 102a.

A laser beam 103 from the exposure scanning unit 100 of FIG. 1 is emitted to the photosensitive drum 101 charged with the above dark potential. The electric potential (light potential: VL) of the laser beam 103 is about −200 V.

By emitting the laser beam 103 having the electric potential (about −200 V) whose absolute value is lower than that of the dark potential (about −800 V) as described above, the absolute value of the electric potential of an electrostatic latent image formed on the irradiated portion (exposed portion) becomes lower than that of the dark potential (about −800 V).

The developing device 104 develops the electrostatic latent image formed on the photosensitive drum 101 by a toner. The developing device 104 has a developing sleeve 104a for charging the toner. A developing bias (for example, DC=−500 V and AC) is applied to the developing sleeve 104a by the developing bias source 112.

The transfer roller 105 transfers a toner image formed on the photosensitive drum 101 onto a recording medium (not shown) such as a recording paper or the like. The transfer roller 105 is constituted by a core metal 105b to which a bias voltage is applied by the bias source 113, and a medium-resistance elastic layer 105a formed on a surface layer thereof. The recording medium is guided to between the transfer roller 105 and the photosensitive drum 101 by the transfer guides 106. After the transfer to the recording medium, the toner, paper particles or the like remaining on the photosensitive drum 101 are removed by a cleaning blade 107a and are collected in the cleaner 107.

The recording medium to which the toner image has been transferred is sent to the fixer 109 via the conveyance guide 108. The fixer 109 has a fixing roller 109a and a pressure roller 109b, and fixes the toner image on the recording medium by pressurizing and heating.

FIG. 3 is a view showing the arrangement relationship of the light sources on the surface-emitting laser 10 of FIG. 1. FIG. 4 is a view showing the relationship between the surface-emitting laser 10 and the collimator lens 11 of FIG. 1. As shown in FIG. 3, the surface-emitting laser 10 has 25 lasers L1, L2, L3 to L25 which are the light sources having output units of the respective laser lights arranged in two-dimension in a lattice pattern. The laser lights respectively emitted from the 25 lasers L1 to L25 are bundled together to form one parallel laser beam by the collimator lens 11 as shown in FIG. 4, and the laser beam enters the aperture 12 of FIG. 1. In FIG. 4, only the laser lights L12a and L14a corresponding to the lasers L12 and L14 are shown for the sake of simplicity, and the laser lights corresponding to the other lasers are omitted from the drawing. The specifications and performance of the 25 lasers L1 to L25 have the same standards, for example, an oscillation wavelength thereof is standardized to about 700 to 800 nm.

The 25 lasers L1 to L25 respectively have laser driving circuits LD1 to LD25 (FIG. 4). The laser driving circuits LD1 to LD25 turn ON/OFF (select) the corresponding lasers L1 to L25, and also switch the light emission intensities corresponding thereto under the control of the laser control unit 200. The laser control unit 200 controls laser emission by the surface-emitting laser 10 based on image data (rasterized signal) from the image processing unit 300. The image processing unit 300, while performing various correction processes or the like on image data, rasterizes the image data as vector information to convert the information into bitmap information.

The laser control unit 200 controls driving of the 25 lasers L1 to L25 of the surface-emitting laser 10 based on the image data of one pixel rasterized by the image processing unit 300. In other words, the laser control unit 200 determines a light emission pattern of the 25 lasers L1 to L25 driving of which is controlled based on the rasterized image data of one pixel based on information of attribute data (color, character/non-character or the like) of the image, density data, image processing data (halftone processing method), or the like. The details will be described below. That is, one pixel is expressed by the light emission pattern of the 25 lasers L1 to L25 of the surface-emitting laser 10.

More specifically, according to the present embodiment, the 25 lasers L1 to L25 of the surface-emitting laser 10 emit a laser light assuming a pattern corresponding to the image data of each pixel and the laser light is focused on one point of the photosensitive drum 101. The shape, diameter and light intensity distribution of the section of the laser beam when an electrostatic latent image related to each pixel is written onto the photosensitive drum 101 can be changed by the light emission pattern of the 25 lasers L1 to L25, and a higher image quality can be thereby obtained.

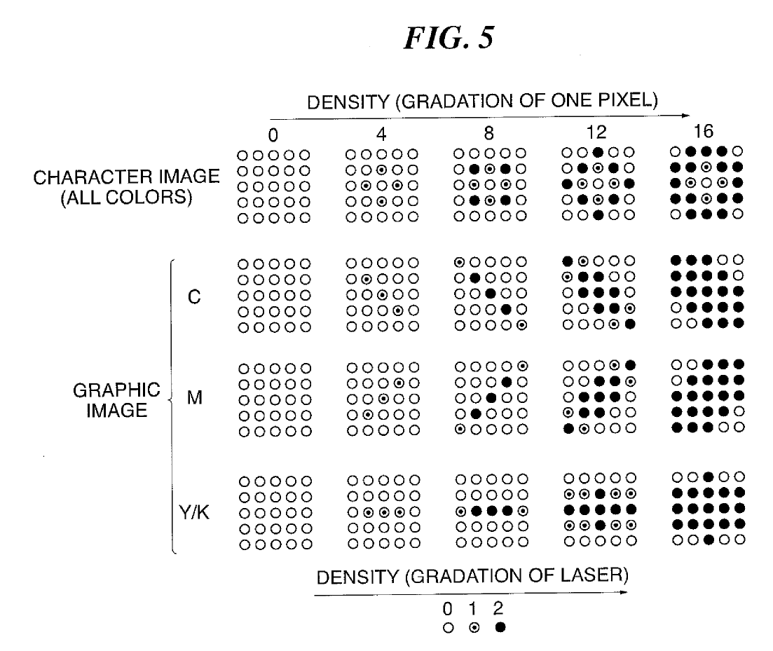

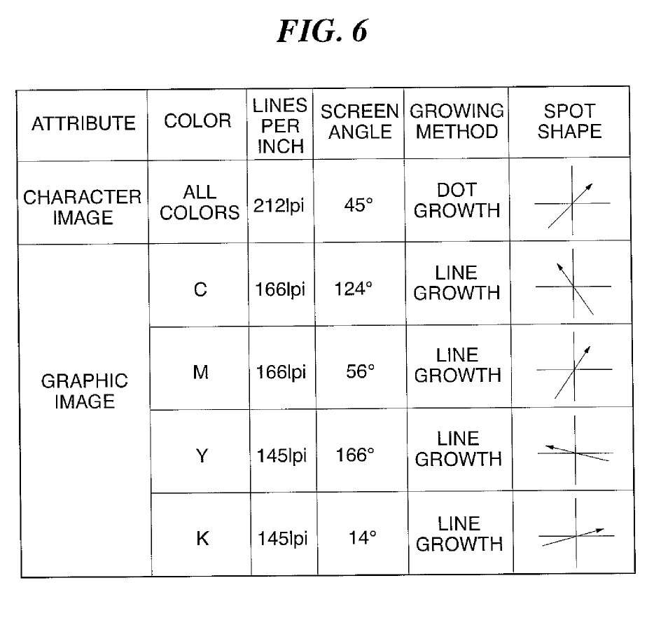

FIG. 5 is a view showing relations of attribute data (color, character, graphic) of an image, densities, and gradations of respective light sources, with light emission patterns. FIG. 6 is a view used for explaining a dither matrix in the case of representing halftone according to an attribute of image data.

In the present embodiment, the writing resolution of the electrostatic latent image is set to 600 DPI. Also, as shown in FIG. 5, the number of gradations of the respective lasers L1 to L25 is set to 3, and the level of each gradation is represented by integers 0 to 2. Also the number of gradations of one pixel is set to 20, and the level of each gradation is represented by integers 0 to 19 by using the 25 lasers L1 to L25. Also, a dither method is used for representing halftone so as to set the number of gradations to 256.

Image data in which information of whether an image is a character image or a graphic image is added as attribute information other than color and density information is input to the image processing unit 300. The image processing unit 300 keeps the attribute information (character image or graphic image) even after performing image processing, rasterizing processing and dither processing, and supplies the image data to the laser control unit 200. The laser control unit 200 determines the light emission pattern of the lasers L1 to L25 related to each pixel based on the information.

As shown in FIG. 6, the image processing unit 300 switches dither matrixes for representing halftone depending on the attribute of the image data.

That is, in the case where the attribute of the image data is a character image, a screen ruling of 212 lpi (lines per inch), a screen angle (growth direction) of 45°, and a growing method of a dot-growing screen in which dots are grown in a halftone-dot pattern are used in respective CMYK colors.

On the other hand, in the case where the attribute of the image data is a graphic image, a growing method of a line-growing screen in which lines are grown in thickness in a parallel-line pattern is used in respective CMYK colors. The screen ruling and the screen angle are changed according to CMYK colors as follows. That is, in the case of C (Cyan), the screen ruling is 166 lpi and the screen angle is 124°. In the case of M (Magenta), the screen ruling is 166 lpi and the screen angle is 56°. In the case of Y (Yellow), the screen ruling is 145 lpi and the screen angle is 166°. In the case of K (Black), the screen ruling is 145 lpi and the screen angle is 14°.

As shown in FIG. 5, when the image data is a character image, light emission patterns on the top row are employed regardless of the color. That is, when the density (gradations of one pixel) is 0-th level, each of the lasers L1 to L25 is set to represent 0-th level (non-emission). When the density is 4-th level, each of the lasers L8, L12, L14, and L18 is set to represent 1-st level and the other lasers are set to represent 0-th level. When the density is 8-th level, each of the lasers LB, L12, L14, and L18 is set to represent 1-st level, each of the lasers L7, L9, L17, and L19 is set to represent 2-nd level, and the other lasers are set to represent 0-th level. When the density is 12-th level, each of the lasers L8, L12, L14, and L18 is set to represent 1-st level, each of the lasers L3, L7, L9, L11, L15, L17, L19 and L23 is set to represent 2-nd level, and the other lasers are set to represent 0-th level. When the density is 15-th level, each of the lasers L8, L12, L14, and L18 is set to represent 1-st level, each of the lasers L2 to L4, L6, L7, L9, L10, L11, L15, L16, L17, L19, L20, and L22 to L24 is set to represent 2-nd level, and the other lasers are set to represent 0-th level. That is, in the case of the image data related to a character image portion, the spot shape of the laser beam is close to a circle, and the light intensity distribution is adjusted so as to obtain a high light intensity in the peripheral portion of the spot diameter in comparison with the light intensity of the center thereof, so that edges of the character image portion are reinforced at high resolution and the toner image after the transfer is close to a rectangle so as not to cause image deterioration due to toner scattering or the like.

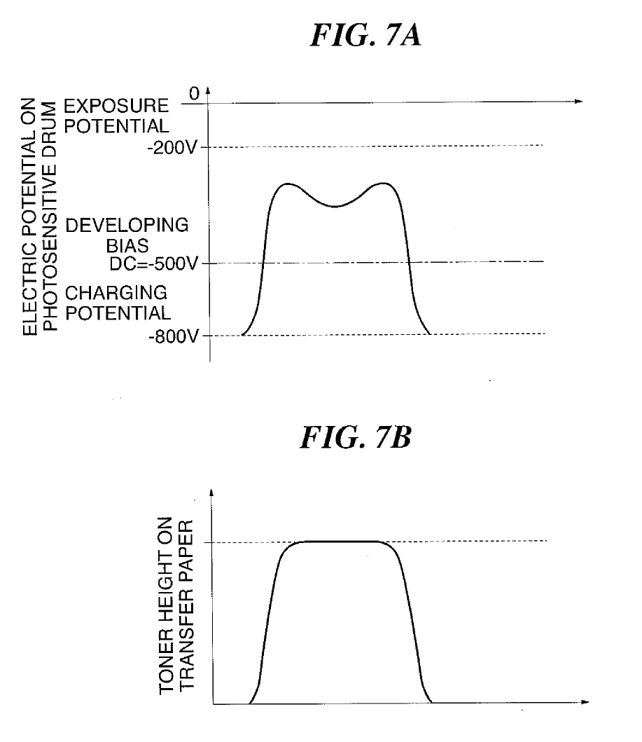

By controlling the spot shape and the light intensity distribution of the laser beam as described above, the electrostatic latent image formed on the surface of the photosensitive drum 101 has an electric potential distribution as shown in FIG. 7A and its toner height on a recording paper is as shown in FIG. 7B.

Thus edges of the character image portion can be reinforced and the reproducibility of the character portion can be improved without deteriorating image due to toner scattering or the like.

Also, in the case of the image data related to a graphic image portion, the reproducibility of gradations is emphasized, and light emission patterns by which the spot shape along the screen growth direction can be obtained are employed. That is, as shown in FIG. 6, light emission patterns by which the spot shape inclined at 135° in the case of Cyan, 45° in the case of Magenta, and the horizontally-long spot shape in the main-scanning direction in the case of Yellow and Black are obtained are employed.

In other words, when the image data is a graphic image, light emission patterns shown in FIG. 5 with respect to C, M, Y, and K are employed in consideration of the screen angles shown in FIG. 6. That is, when the density is 0-th level, each of the lasers L1 to L25 is set to represent 0-th level (non-emission) in respective C, M, Y, and K.

To be more specific, in consideration that the screen angle of C is 124° as shown in FIG. 6, when the density of Cyan is 4-th level, each of the lasers L7, L13, and L19 is set to represent 1-st level and the other lasers are set to represent 0-th level. When the density of Cyan is 8-th level, each of the lasers L1 and L25 is set to represent 1-st level, each of the lasers L7, L13, and L19 is set to represent 2-nd level, and the other lasers are set to represent 0-th level. When the density of Cyan is 12-th level, each of the lasers L2, L6, L20, and L24 is set to represent 1-st level, each of the lasers L1, L7, L8, L12 to L14, L18, L19 and L25 is set to represent 2-nd level, and the other lasers are set to represent 0-th level. When the density of Cyan is 15-th level, each of the lasers L1 to L3, L6 to L9, L11 to L15, L17 to L20 and L23 to L25 is set to represent 2-nd level, and the other lasers are set to represent 0-th level. Similarly, in consideration that the screen angles of M, Y and K are respectively 56°, 166°, and 14°, gradations of respective densities of Magenta, Yellow, and Black are represented by the patterns shown in FIG. 5.

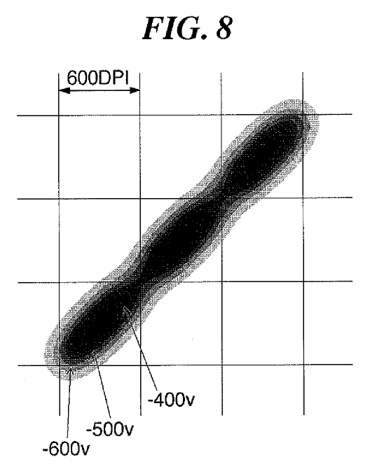

The electric potential distribution of the electrostatic latent image formed by the laser beam having the above spot shape is as shown in FIG. 8. That is, the electrostatic latent images of adjacent pixels are connected at an early stage, and a more stable output image can be obtained. The reproducibility of the graphic image portion can be thereby improved.

It is to be understood that the present invention is not limited to the above embodiment. For example, the number of the lasers which are separately emission-controlled based on the image data of one pixel may be different from “25”. Also, the laser lights emitted from the plurality of lasers may be focused to form one laser beam by a device other than the collimator lens 11.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of any of the embodiments described above, and hence the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, DVD-ROM, a DVD-RAM, a DVD-RW, a DVD+RW, a magnetic tape, a nonvolatile memory card, and a ROM. Alternatively, the program may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all such modifications, equivalent structures and functions.

This application claims the benefit of Japanese Patent Application Nos. 2007-180972 filed Jul. 10, 2007, and 2008-175618 filed Jul. 4, 2008, which are hereby incorporated by reference herein in their entirety.

What is claimed is:

1. An image forming apparatus for exposing a photosensitive body by laser lights which are emission-controlled based on image data and forming an image, comprising:
a light source unit having a plurality of lasers;
a control unit adapted to separately control emission of the plurality of lasers based on image data of one pixel;
a beam forming unit adapted to focus the laser lights emitted from the plurality of lasers by the emission control of said control unit and form a laser beam; and
a scanning unit adapted to perform exposure scanning of the photosensitive body by the laser beam from said beam forming unit, wherein
said control unit changes a light emission pattern of the plurality of lasers according to image data of each pixel.

2. The image forming apparatus according to claim 1, wherein the plurality of lasers of said light source unit are configured so as to arrange output units of the laser lights thereof in two-dimension.

3. The image forming apparatus according to claim 1, wherein said control unit selects a laser to emit a light from the plurality of lasers, and switches light emission intensity thereof to change the light emission pattern of the plurality of lasers according to the image data of each pixel.

4. The image forming apparatus according to claim 1, wherein the image data of each pixel has one of the group comprised of information of a color, a density, and a halftone processing method, and said control unit changes the light emission pattern of the plurality of lasers according to the information.

5. A method for controlling an image forming apparatus for exposing a photosensitive body by laser lights which are emission-controlled based on image data and forming an image, comprising:
a light emission controlling step of separately controlling emission of a plurality of lasers provided in a light source unit based on image data of one pixel;
a beam forming step of focusing the laser lights emitted from the plurality of lasers and forming a laser beam; and
a scanning step of performing exposure scanning of the photosensitive body by the laser beam, wherein
said light emission controlling step comprises changing a light emission pattern of the plurality of lasers according to image data of each pixel.

6. The method for controlling an image forming apparatus according to claim 5, wherein said light emission controlling step comprises selecting a laser to emit a light from the plurality of lasers, and switching light emission intensity thereof to change the light emission pattern of the plurality of lasers according to the image data of each pixel.

7. The method for controlling an image forming apparatus according to claim 6, wherein the image data of each pixel has one of the group comprised of information of a color, a density, and a halftone processing method, and said light emission controlling step comprises changing the light emission pattern of the plurality of lasers according to the information.
